(19) United States
(12) Patent Application Publication
(10) Pub. No.: US 2006/0199568 A1
(43) Pub. Date: Sep. 7, 2006

(54) Method for providing a search service using a mobile communication terminal and mobile communication terminal and server therefor

(75) Inventors: Jae-Joon Seo, Seoul (KR); Joong-Mock Shin, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/329,798

(22) Filed: Jan. 11, 2006

(30) Foreign Application Priority Data
Mar. 7, 2005 (KR) 10-2005-0018712

(51) Int. Cl. H04Q 7/38

(52) U.S. Cl. 455/414.1

(57) ABSTRACT

A mobile communication terminal includes a Synchronization Markup Language (SyncML) Device Management (DM) client having a preset management tree for a search. The mobile communication terminal accesses a SyncML DM server, sends search information corresponding to the management tree and an execution command from the SyncML DM client to the SyncML DM server according to a SyncML DM protocol, and receives a search result through the designated messaging service. A server includes the SyncML DM server having the management tree and a search server. The SyncML DM server receives the search information and the execution command from the client according to the SyncML DM protocol, and sends a search execution request to the search server. The search server executes a search in response to the request, and transmits a search result based on the search execution to the mobile communication terminal through a messaging service designated in the search information.

### PRIORITY

This application claims priority under 35 U.S.C. § 119 to an application entitled “Method for Providing a Search Service Using a Mobile Communication Terminal, and Mobile Communication Terminal and Server Therefor” filed in the Korean Intellectual Property Office on Mar. 7, 2005 and assigned Serial No. 2005-18712, the contents of which are incorporated herein by reference.

### BACKGROUND OF THE INVENTION

1. Field of the Invention

The present invention generally relates to a mobile communication terminal, and more particularly to a search service using a mobile communication terminal.

2. Description of the Related Art

Conventionally, Internet search services in mobile communication terminals use a Wireless Application Protocol (WAP) browser or Java. When the WAP browser is used, it accesses a web site for a wireless Internet search, inputs a desired search keyword, and performs the search. When a Java midlet is implemented in a mobile communication terminal, it may access a server to perform a search.

In mobile communication terminals, the Internet search methods using the WAP browser and Java access a server and a search engine web site, input a keyword, and maintain a network connection to conduct the search. These search methods have problems with billing and network instability.

Mobile communication service fees are generally greater than wired communication service fees. Because a network connection is continuously maintained during the Internet search, exorbitant communication fees result. The connection time for the search includes all the time from the start of the search until the completion of the search. As a result, the user pays unnecessary fees for the network connection service while waiting for the search results. Since mobile communication networks are not as stable as wired communication networks, during time spent waiting for search results, the network connection may be cut off because of a bad mobile communication environment. In this case, the user must re-perform the Internet search.

The user may want to use data obtained through a search at a later time, after storing personal information, i.e., personal information management system (PIMS) data, in a web server. When the mobile communication terminal is lost, data stored in the mobile communication terminal may be retrieved if it had been backed up to the web server. Because of the web server's large storage capacity, the user may want to store the mobile communication terminal data on the web server.

Data stored on the web server can be retrieved using the WAP browser embedded in the mobile communication terminal. When searching for data on the mobile communication terminal, the same problems result as the Internet search because the mobile communication terminal must access the web server and maintain a network connection the whole time the search is being conducted.

### SUMMARY OF THE INVENTION

It is, therefore, an object of the present invention to avoid unnecessary fees and reduce the negative effects of an unstable mobile communication network during an Internet search using a mobile communication terminal.

It is another object of the present invention to avoid unnecessary fees, and reduce the negative effects of an unstable mobile communication network while allowing a user to store desired data in a server and search the stored data using a mobile communication terminal.

It is yet another object of the present invention to receive a search result, even when a network connection is not maintained, after an Internet or data search is started using a mobile communication terminal.

To achieve the above and other objects of the present invention, a mobile communication terminal includes a Synchronization Markup Language (SyncML) Device Management (DM) client having a preset management tree for a search. The mobile communication terminal accesses a SyncML DM server, sends search information corresponding to the management tree and an execution command from the SyncML DM client to the SyncML DM server according to a SyncML DM protocol, and receives a search result through a designated messaging service.

Also, to achieve the above and other objects of the present invention, a server includes a Synchronization Markup Language (SyncML), Device Management (DM) server having a management tree for a search, and a search server connected thereto. The SyncML DM server receives search information corresponding to the management tree for the search, and an execution command from a SyncML DM client of a mobile communication terminal according to the SyncML DM protocol, and sends a search execution request based on the search information to the search server. The search server executes a search based on the search information in response to the search execution request of the SyncML DM server, and transmits a search result based on the search execution to the mobile communication terminal through a messaging service designated in the search information.

Preferably, the designated messaging service may be at least one of a Short Messaging Service (SMS), a Multimedia Messaging Service (MMS), and an Electronic Mail (E-mail) service.

### BRIEF DESCRIPTION OF THE DRAWINGS

The above and other aspects and advantages of the present invention will be more clearly understood from the following detailed description taken in conjunction with the accompanying drawings, in which:

FIG. 1 is a block diagram illustrating a structure of a search service system in accordance with an embodiment of the present invention;

FIG. 2 illustrates a management tree structure in accordance with an embodiment of the present invention;

FIG. 3 is a flow chart illustrating a process of a mobile communication terminal in accordance with an embodiment of the present invention; and

FIG. 4 illustrates a procedure for providing a search service in accordance with an embodiment of the present invention.

### DETAILED DESCRIPTION OF THE PREFERRED EMBODIMENTS

Preferred embodiments of the present invention will be described in detail herein below with reference to the accompanying drawings. In the following description, detailed descriptions of functions and configurations incorporated herein that are well known to those skilled in the art are omitted for clarity and conciseness.

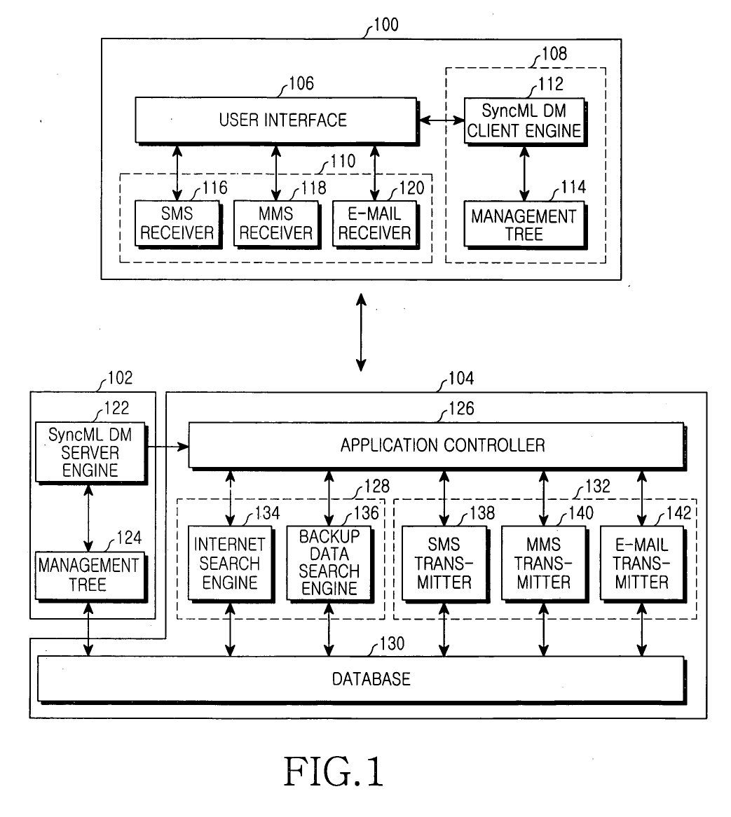

FIG. 1 is a block diagram illustrating a structure of a search service system in accordance with an embodiment of the present invention. A mobile communication terminal 100 including a Synchronization Markup Language (SyncML) Device Management (DM) client 108 is provided with an Internet search and a backup data search service from a search server 104 through a SyncML DM server 102.

SyncML DM is a mobile communication terminal management standard based on SyncML created in Open Mobile Alliance (OMA). This standard is an extended SyncML standard for management purposes to provide data synchronization technology in a mobile communication environment. SyncML DM is performed through management information exchange between a management server and a management agent. Client provisioning, Firmware Over The Air (FOTA) download, backup & restore, and so on, are application functions of a SyncML DM protocol that are currently being discussed in the OMA.

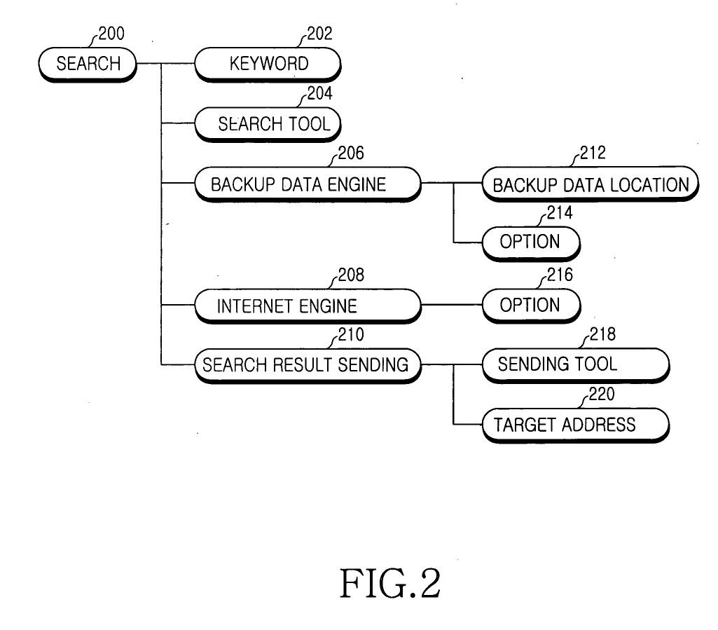

The mobile communication terminal 100 includes a user interface 106, the SyncML DM client 108, and a message receiver 110. The SyncML DM client 108 includes a SyncML DM client engine 112, and a preset management tree 114 for a search in accordance with an embodiment of the present invention. The management tree 114 will be described below with reference to FIG. 2. The message receiver 110 includes a Short Messaging Service (SMS) receiver 116, a Multimedia Messaging Service (MMS) receiver 118, and an Electronic Mail (E-mail) receiver 120.

The SyncML DM client 108 accesses a SyncML DM server 102 through the SyncML DM client engine 112, and sends search information corresponding to the management tree 114 for an Internet or backup data search, and an execution command to the SyncML DM server 102 according to a SyncML DM protocol.

The search information is input from a user through the user interface 106. The user interface 106 includes a key input unit, a display unit for displaying an image, and a microphone and speaker for voice input/output.

The SyncML DM server 102 includes a SyncML DM server engine 122 and a preset management tree 124 for a search like the management tree 114 of the SyncML DM client 108. The management tree 124 is illustrated in FIG. 2. The SyncML DM server 102 receives search information corresponding to the management tree 124 for an Internet or backup data search, and an execution command from the SyncML DM client 108 through the SyncML DM server engine 122 according to the SyncML DM protocol. The SyncML DM server 102 sends an Internet search request based on the search information to a search server 104.

The search server 104 connects to the SyncML DM server 102 and executes an Internet search or a backup data search based on the search information in response to the search request from the SyncML DM server 102. The search server 104 sends the search result to the mobile communication terminal 100 according to the messaging service designated in the search information. This search server 104 includes an application controller 126, a search engine 128, a database 130, and a message transmitter 132.

The search engine 128 includes an Internet search engine 134 for the Internet search and a backup data search engine 136 for the backup data search. The Internet search engine 134 and the backup data search engine 136 are configured such that the mobile communication terminal 100 can output search results. For example, the Internet search engine 134 may be used for the conventional mobile communication terminal. The message transmitter 132 includes an SMS transmitter 138, an MMS transmitter 140, and an E-mail transmitter 142.

The application controller 126 controls the Internet search engine 134 to execute the Internet search in response to the Internet search request from the SyncML DM server 102 or controls the backup data search engine 136 to execute the backup data search in response to the backup data search request from the SyncML DM server 102. Then, the application controller 126 controls the message transmitter 132 to transmit the search results to the mobile communication terminal 100. In this case, the application controller 126 controls the SMS transmitter 138, the MMS transmitter 140, and the E-mail transmitter 142 to transmit a search result according to a type of a messaging service designated in the search information. Moreover, the application controller 126 stores the Internet search result as backup data in the database 130.

The database 130 can store the Internet search result as backup data. The user can access the search server 104 using the mobile communication terminal 100 or a personal computer (PC) to store personal information or other data in the database 130.

The SyncML DM server 102 and the search server 104 can be connected to the Internet, a local area network (LAN), or an intranet constructed by a provider or mobile communication provider for providing the search service in accordance with the present invention. Accordingly, the mobile communication terminal 100 accesses the SyncML DM server 102 through the Internet, LAN, or intranet coupled to a mobile communication network.

FIG. 2 illustrates an example of the management tree 114 included in the SyncML DM client 108 and the management tree 124 included in the SyncML DM server 102. Management objects including management information have a hierarchical structure of a tree form according to the SyncML DM protocol. The management objects such as a keyword node 202, a search tool node 204, a backup data engine node 206, an Internet engine node 208, a search result sending node 210, and so on are lower nodes linked to a search node 200 serving as a root node.

The keyword node 202 is a management object that sets a search keyword for an Internet search or backup data search.

The search tool node 204 is a management object that sets the type of search selected from the Internet search and the backup data search.

The backup data engine node 206 is a management node that sets information requested by the backup data search engine 136 of the search server 104. The backup data engine node 206 includes a backup data location node 212 and an option node 214 serving as lower nodes.

The backup data location node 212 is a management object that sets a backup data location, i.e., a location of data to be retrieved by the user from backup data stored in the database 130 of the search server 104. For example, when data associated with an address book, schedule management, E-mail, and so on is stored as backup data in the database 130, a backup data location indicates one of categories of the address book, schedule management, E-mail, and so on, selected by the user.

The option node 214 is a management object for setting an option value when the backup data search engine 136 of the search server 104 requests an option.

The Internet engine node 208 is a management object that sets information requested by the Internet search engine 134 of the search server 104. The Internet engine node 208 includes an option node 216 serving as a lower node.

The option node 216 is a management object for setting an option value when the Internet search engine 134 of the search server 104 requests an option.

The search result sending node 210 is a management object that sets information for transmitting the Internet search result or the backup data search result from the search server 104. The search result sending node 210 includes a sending tool node 218 and a target address node 220.

The sending tool node 218 is a management object that sets a type of messaging service selected from the SMS, MMS and E-mail service.

The target address node 220 is a management object that sets an address of the mobile communication terminal 100. For example, when a type of messaging service is designated as the SMS, an address set in the target address node 220 is a phone number of the mobile communication terminal 100.

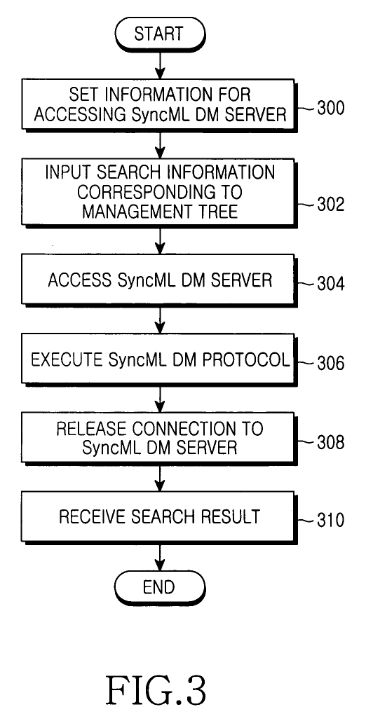

A process in the mobile communication terminal 100 will be described with reference to steps 300 to 310 of FIG. 3. In step 300, access information for the SyncML DM server 102 input by a user via the user interface 106. The access information includes a uniform resource locator (URL) or Internet protocol (IP) address of the SyncML DM server 102, a server identifier (ID) and password of the SyncML DM server 102, and a device login ID and password preset according to the SyncML DM protocol.

The access information can be set by direct user input or client provisioning. Conventionally, the function for setting the access information by client provisioning sends, to the mobile communication terminal, access information for accessing a server associated with various clients such as a wireless application protocol (WAP), MMS, E-mail, and so on using a WAP push function, such that the mobile communication terminal can store the access information. When the user only inputs a phone number and a model name to a web site, setting values associated with the access information are sent to the mobile communication terminal through the WAP push function. Thus, even when the user does not know the setting values associated with the access information, the clients of the mobile communication terminal can be used.

When the access information is set, the user inputs search information corresponding to the management tree 114 as illustrated in FIG. 2 via the user interface 106 in step 302. In this case, the search information includes a search keyword and search tool information for designating a type of Internet search or backup data search. When the backup data search is performed, the search information includes backup data engine information and backup data location information. When the Internet search is performed, the search information includes Internet engine information. Additionally, the search information includes sending tool information for designating a messaging service for transmitting the search result and target address information.

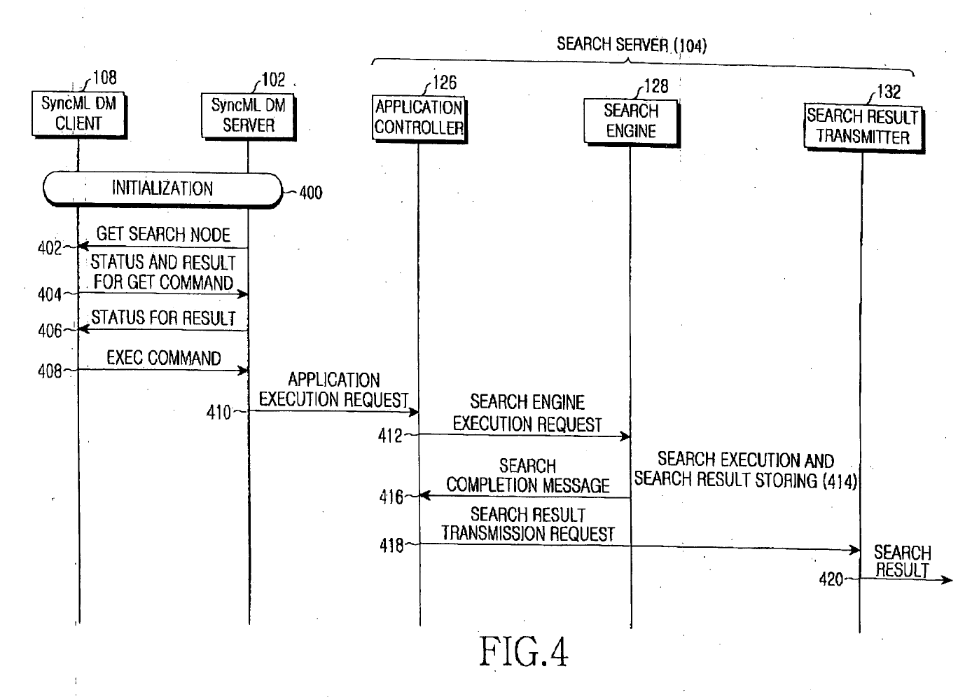

After accessing the SyncML DM server 102 in step 304, the SyncML DM client engine 112 executes the SyncML DM protocol in step 306. The SyncML DM protocol will be described below with reference to steps 400 to 408 of FIG. 4.

FIG. 4 illustrates the SyncML DM protocol execution and a search service procedure. Referring to FIG. 4, the SyncML DM client 108 and the SyncML DM server 102 perform initialization according to the SyncML DM protocol in step 400. In this case, an authentication procedure and a device information transmission procedure based on the SyncML DM protocol are performed.

The SyncML DM server 102 sends a message of ‘Get search node’ to the SyncML DM client 108 according to the SyncML DM protocol, and searches the management tree of the SyncML DM client 108 in step 402. That is, the SyncML DM server 102 requests management information of the search node based on the structure as illustrated in FIG. 2.

The SyncML DM client 108 sends, to the SyncML DM server 102, search information serving as parameters corresponding to the management tree 114 through a message of ‘Status and Result for Get Command’ according to the SyncML DM protocol in step 404. When the SyncML DM server 102 receives the search information, it sends, to the SyncML DM client 108, a message of ‘Status for Result’ as a response according to the SyncML DM protocol in step 406.

The SyncML DM client 108 sends, to the SyncML DM server 102, a message of ‘Exec command’ serving as an execution command according to the SyncML DM protocol in step 408.

Therefore, the search information for the Internet search or backup data search and the execution command are sent from the SyncML DM client 108 to the SyncML DM server 102.

Then, the SyncML DM client 108 releases the connection to the Sync DM server 102 as shown in step 308 of FIG. 3. That is, the SyncML DM client 108 releases the connection to the SyncML DM server 102 after sending the search information for the Internet search or backup data search and the execution command.

Referring back to FIG. 4, upon receiving the search information for the Internet search or backup data search and the execution command from the SyncML DM client 108, the SyncML DM server 102 requests search execution by sending an “Application Execution Request” message to the application controller 126 of the search server 104 in step 410.

The application controller 126 sends, to the search engine 128, a message for requesting the execution of either the Internet search engine 134 or the backup data search engine 136 designated in the search information in step 412. The Internet search or backup data search is executed according to a keyword included in the search information that designates the Internet search engine 134 or the backup data search engine 136. When the Internet search is executed, the Internet search engine 134 stores the search result as backup data in the database 130 in step 414, so that the user can later retrieve the stored search result using the backup data search rather than the Internet search.

When the Internet search or backup data search is completed, the Internet search engine 134 or the backup data search engine 136 sends a “Search Completion Message” to the application controller 126 in step 416. The application controller 126 sends a “Search Result Transmission Request” message to the search result transmitter 132 in step 418. The application controller 126 sends the Search Result Transmission Request message to one of the SMS transmitter 138, the MMS transmitter 140, and the E-mail transmitter 142 according to the messaging service designated in the search information. The designated messing service transmits the search result to the mobile communication terminal 100 through the application controller 126 according to the designated messaging service in step 420.

Referring back to FIG. 3, after releasing the connection to the SyncML DM server 102 in step 308, the mobile communication terminal 100 receives the search result in the step 310. In this case, the SMS receiver 116, the MMS receiver 118, or the E-mail receiver 120 based on the messaging service designated in the search information, i.e., the receiver mapped to the messaging service used to provide the search result from the search server 104, receives the search result. The received search result is output to the user through the user interface 106.

In accordance with the present invention, the user can perform an Internet search using a mobile communication terminal. Moreover, the user can also perform a backup data search when needed by using the mobile communication terminal. The present invention can avoid unnecessary fees and reduce the negative effects of an unstable mobile communication network by receiving a search result without maintaining a network connection after a search is started.

Although preferred embodiments of the present invention have been disclosed for illustrative purposes, those skilled in the art will appreciate that various modifications, additions, and substitutions are possible, without departing from the scope of the present invention.

An example in which a search result is provided through one messaging service of an SMS, MMS, and E-mail service has been described. Alternatively, the search result may be provided through another messaging service such as an instant messenger. Additionally, the search result can be transmitted to the mobile communication terminal using SyncML DM.

As illustrated in FIG. 1, the SyncML DM server 102 and the search server 104 are separated from each other and are coupled to each other through a network. Alternatively, the SyncML DM server 102 and the search server 104 may be integrated into one server.

An example in which data back up to the search server 104 by the user is retrieved during a backup data search has been described. Alternatively, data stored by a mobile communication provider or search service provider may also be retrieved using the SyncML DM protocol.

Therefore, the present invention is not limited to the above-described embodiments, but is defined by the following claims, along with their full scope of equivalents.

What is claimed is:

1. A method for providing a search service using a mobile communication terminal, comprising the steps of:
accessing a Synchronization Markup Language (SyncML) Device Management (DM) server from the mobile communication terminal, wherein the mobile communication terminal is a SyncML DM client having a preset management tree for a search and the SyncML DM server is connected to a search server;
sending search information corresponding to the management tree and an execution command from the SyncML DM client to the SyncML DM server;
sending a search execution request based on the search information from the SyncML DM server to the search server;
executing a search based on the search information in the search server in response to the search execution request of the SyncML DM server;
transmitting a search result based on the search execution request from the search server to the mobile communication terminal through a messaging service designated in the search information; and
receiving the search result in the mobile communication terminal through the designated messaging service.

2. The method of claim 1, further comprising the step of:
releasing a connection to the SyncML DM server after the search information and the execution command are sent to the SyncML DM server.

3. The method of claim 2, wherein the designated messaging service is at least one of a Short Messaging Service (SMS), a Multimedia Messaging Service (MMS), and an Electronic Mail (E-mail) service.

4. The method of claim 1, further comprising the step of:
storing, by the search server, the search result as backup data in a database.

5. The method of claim 2, further comprising the step of:
storing, by the search server, the search result as backup data in a database.

6. The method of claim 1, wherein the management tree comprises:
a keyword node in which a search keyword is set;
an Internet engine node in which Internet search engine information is set; and
a search result sending node in which transmission information of the search result is set, the search result sending node comprising:
a sending tool node in which the designated messaging service is set; and
a target address node in which an address of the mobile communication terminal is set.

7. The method of claim 2, wherein the management tree comprises:
a keyword node in which a search keyword is set;
an Internet engine node in which Internet search engine information is set; and
a search result sending node in which transmission information of the search result is set, the search result sending node comprising:
a sending tool node in which the designated messaging service is set; and
a target address node in which an address of the mobile communication terminal is set.

8. The method of claim 1, wherein the management tree comprises:
a keyword node in which a search keyword is set;
a backup data engine node in which backup data search engine information is set; and
a search result sending node in which transmission information of the search result is set, the search result sending node comprising:
a sending tool node in which the designated messaging service is set; and
a target address node in which an address of the mobile communication terminal is set.

9. The method of claim 2, wherein the management tree comprises:
a keyword node in which a search keyword is set;
a backup data engine node in which backup data search engine information is set; and
a search result sending node in which transmission information of the search result is set, the search result sending node comprising:
a sending tool node in which the designated messaging service is set; and
a target address node in which an address of the mobile communication terminal is set.

10. The method of claim 1, wherein the management tree comprises:
a keyword node in which a search keyword is set;
a search tool node in which a type of a search is set;
a backup data engine node in which backup data search engine information is set;
an Internet engine node in which Internet search engine information is set; and
a search result sending node in which transmission information of the search result is set, the search result sending node comprising:
a sending tool node in which the designated messaging service is set; and
a target address node in which an address of the mobile communication terminal is set.

11. The method of claim 2, wherein the management tree comprises:
a keyword node in which a search keyword is set;
a search tool node in which a type of a search is set;
a backup data engine node in which backup data search engine information is set;
an Internet engine node in which Internet search engine information is set; and
a search result sending node in which transmission information of the search result is set, the search result sending node comprising:
a sending tool node in which the designated messaging service is set; and
a target address node in which an address of the mobile communication terminal is set.

12. A method for providing a search service in a mobile communication terminal comprising a Synchronization Markup Language (SyncML) Device Management (DM) client having a preset management tree for a search, comprising the steps of:
accessing a SyncML DM server, having the management tree;
sending search information corresponding to the management tree and an execution command to the SyncML DM server; and
receiving a search result in the mobile communication terminal through a messaging service designated in the search information.

13. The method of claim 12, further comprising the step of:
releasing a connection to the SyncML DM server after the search information and the execution command are sent to the SyncML DM server.

14. The method of claim 12, wherein the designated messaging service is at least one of a Short Messaging Service (SMS), a Multimedia Messaging Service (MMS), and an Electronic Mail (E-mail) service.

15. The method of claim 12, wherein the management tree comprises:
a keyword node in which a search keyword is set;
an Internet engine node in which Internet search engine information is set; and
a search result sending node in which transmission information of the search result is set, the search result sending node comprising:
a sending tool node in which the designated messaging service is set; and
a target address node in which an address of the mobile communication terminal is set.

16. The method of claim 13, wherein the management tree comprises:
a keyword node in which a search keyword is set;
an Internet engine node in which Internet search engine information is set; and
a search result sending node in which transmission information of the search result is set, the search result sending node comprising:
a sending tool node in which the designated messaging service is set; and
a target address node in which an address of the mobile communication terminal is set.

17. The method of claim 12, wherein the management tree comprises:
a keyword node in which a search keyword is set;
a backup data engine node in which backup data search engine information is set; and
a search result sending node in which transmission information of the search result is set, the search result sending node comprising:
a sending tool node in which the designated messaging service is set; and
a target address node in which an address of the mobile communication terminal is set.

18. The method of claim 13, wherein the management tree comprises:
a keyword node in which a search keyword is set;
a backup data engine node in which backup data search engine information is set; and
a search result sending node in which transmission information of the search result is set, the search result sending node comprising:
a sending tool node in which the designated messaging service is set; and
a target address node in which an address of the mobile communication terminal is set.

19. The method of claim 12, wherein the management tree comprises:
a keyword node in which a search keyword is set;
a search tool node in which a type of a search is set;
a backup data engine node in which backup data search engine information is set;
an Internet engine node in which Internet search engine information is set; and
a search result sending node in which transmission information of the search result is set, the search result sending node comprising:
a sending tool node in which the designated messaging service is set; and
a target address node in which an address of the mobile communication terminal is set.

20. The method of claim 13, wherein the management tree comprises:
a keyword node in which a search keyword is set;
a search tool node in which a type of a search is set;
a backup data engine node in which backup data search engine information is set;
an Internet engine node in which Internet search engine information is set; and
a search result sending node in which transmission information of the search result is set, the search result sending node comprising:
a sending tool node in which the designated messaging service is set; and
a target address node in which an address of the mobile communication terminal is set.

21. A method for providing a search service from a server to a mobile communication terminal, wherein the server comprises a Synchronization Markup Language (SyncML) Device Management (DM) server having a preset management tree for a search and a search server connected thereto, and the mobile communication terminal comprises a SyncML DM client having the management tree, the method comprising the steps of:
receiving search information corresponding to the management tree and an execution command from the SyncML DM client;
sending a search execution request based on the search information from the SyncML DM server to the search server;
executing a search based on the search information in response to the search execution request; and
transmitting a search result based on the search execution from the search server to the mobile communication terminal through a messaging service designated in the search information.

22. A mobile communication terminal for providing a search service through a server comprising a Synchronization Markup Language (SyncML) Device Management (DM) server having a preset management tree for a search and a search server connected thereto, comprising:
a SyncML DM client, having the management tree, for accessing the SyncML DM server and sending search information corresponding to the management tree for the search and an execution command to the SyncML DM server according to a SyncML DM protocol; and
a receiver for receiving a search result through a messaging service designated in the search information.

23. The mobile communication terminal of claim 22, wherein the SyncML DM client releases a connection to the SyncML DM server after the search information and the execution command are sent to the SyncML DM server.

24. The mobile communication terminal of claim 23, wherein the designated messaging service is at least one of a Short Messaging Service (SMS), a Multimedia Messaging Service (MMS), and an Electronic Mail (E-mail) service.

25. The mobile communication terminal of claim 22, wherein the management tree comprises:
a keyword node in which a search keyword is set;
an Internet engine node in which Internet search engine information is set; and
a search result sending node in which transmission information of the search result is set, the search result sending node comprising:
a sending tool node in which a type of the designated messaging service is set; and
a target address node in which an address of the mobile communication terminal is set.

26. The mobile communication terminal of claim 23, wherein the management tree comprises:
a keyword node in which a search keyword is set;
an Internet engine node in which Internet search engine information is set; and
a search result sending node in which transmission information of the search result is set, the search result sending node comprising:
a sending tool node in which a type of the designated messaging service is set; and
a target address node in which an address of the mobile communication terminal is set.

27. The mobile communication terminal of claim 22, wherein the management tree comprises:
a keyword node in which a search keyword is set;
a backup data engine node in which backup data search engine information is set; and
a search result sending node in which transmission information of the search result is set, the search result sending node comprising:
a sending tool node in which the designated messaging service is set; and
a target address node in which an address of the mobile communication terminal is set.

28. The mobile communication terminal of claim 23, wherein the management tree comprises:
a keyword node in which a search keyword is set;
a backup data engine node in which backup data search engine information is set; and
a search result sending node in which transmission information of the search result is set, the search result sending node comprising:
a sending tool node in which the designated messaging service is set; and
a target address node in which an address of the mobile communication terminal is set.

29. The mobile communication terminal of claim 22, wherein the management tree comprises:
a keyword node in which a search keyword is set;
a search tool node in which a type of a search is set;
a backup data engine node in which backup data search engine information is set;
an Internet engine node in which Internet search engine information is set; and
a search result sending node in which transmission information of the search result is set, the search result sending node comprising:
a sending tool node in which a type of the designated messaging service is set; and
a target address node in which an address of the mobile communication terminal is set.

30. The mobile communication terminal of claim 23, wherein the management tree comprises:
a keyword node in which a search keyword is set;
a search tool node in which a type of a search is set;
a backup data engine node in which backup data search engine information is set;
an Internet engine node in which Internet search engine information is set; and
a search result sending node in which transmission information of the search result is set, the search result sending node comprising:
a sending tool node in which a type of the designated messaging service is set; and
a target address node in which an address of the mobile communication terminal is set.

31. A server for providing a search service to a mobile communication terminal comprising a Synchronization Markup Language (SyncML) Device Management (DM) client having a preset management tree for a search, comprising:
a SyncML DM server, having the management tree, for connecting to the SyncML DM client, receiving search information corresponding to the management tree and an execution command from the SyncML DM client, and sending a search execution request based on the search information from the SyncML DM server to a search server;
wherein the search server executes a search based on the search information in response to the search execution request of the SyncML DM server, and transmits a search result based on the search execution to the mobile communication terminal through a messaging service designated in the search information.
